(19) United States
(12) Patent Application Publication
(10) Pub. No.: US 2008/0080210 A1
(43) Pub. Date: Apr. 3, 2008

(54) Lamp cover with bending structure and backlight module

(75) Inventors: Jyun-An Jiang, Padeh City (TW); Chin-Yung Lin, Padeh City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CHUNGHWA PICTURE TUBES, LTD

(21) Appl. No.: 11/646,308

(22) Filed: Dec. 28, 2006

(30) Foreign Application Priority Data
Sep. 29, 2006 (TW) 95136274

(51) Int. Cl. F21V 7/04

(52) U.S. Cl. 362/614

(57) ABSTRACT

A lamp cover with a bending structure is provided, which includes: a light part having a upper frame and a side frame connected to the upper frame; a supporting part having a first end and a second end, wherein the first end is connected to the side frame and the second end is configured away from the light part by a distance, and an accommodating space is set between the light part and the first end of the supporting part to accommodate a light source; and a bending part connected to the second end of the supporting part and bended into an angle. The lamp cover with a bending structure is applied in a backlight module, and the lamp cover will not deform to leak light when suffering a shock.

### BACKGROUND OF THE INVENTION

1. Field of the Invention

The present invention relates to a backlight module, and more particularly, to a lamp cover with a bending structure of a backlight module.

2. Description of the Prior Art

The Thin Film Transistor-Liquid Crystal Display (TFT-LCD) is the most popular Flat Panel Display (FPD) recently. It has many benefits such as low power consumption, thin shape, light weight, and low driving voltage, etc. Therefore, it is widely applied in many electronic apparatuses, such as the notebook computer, the laptop computer and the television.

Generally a TFT-LCD panel is constituted by two substrates, a Thin Film Transistor (TFT) substrate and a Color Filter (CF) substrate having electrodes thereof. The liquid crystal is filled between two substrates. Because the TFT-LCD is not self-illuminated, it needs a backlight module to provide the light source for the image display. Its light transmittance is controlled by applying the signal voltage to the respective electrode, and so as to obtain the proper image display.

FIG. 1A is a partial side-view schematic diagram of the structure of a conventional backlight module, and FIG. 1B is the solid schematic diagram of FIG. 1A. A lamp cover 10 is a hollow structure with an opening to accommodate a light source 12. A light guide plate 16 and a reflector film 14 are located on the bottom of the lamp cover 10 and partially inserted into the opening of the lamp cover 10. The illuminated light from the light source 12 is reflected by the lamp cover 10 and the reflector film 14, and then emitted through the display area of the light guide plate 16 to provide the light source for the image display. The cover plate 18 is set under the bottom of the lamp cover 10 to reinforce the structure strength.

This kind of backlight module is heavy, thick and costly. Therefore, some backlight modules omit the cover plate for the structure reinforcement and adopt the design of using the lamp cover to hold the lamp tube, and so as to make the backlight module lighter, thinner and cost-effective. This kind of design utilizes the screws and the adhesive tapes to fix the lamp cover to the display panel.

However, the structure of the backlight module without a cover plate is not strong enough and easily deformed to turn over to make the display area leak light when suffering a shock although it has the screws and the adhesive tapes for the structure reinforcement, therefore the display quality and the optical flavor of the display are degraded.

### SUMMARY OF THE INVENTION

In order to solve the aforementioned problems, one object of the present invention is to provide a lamp cover with a bending structure and a backlight module to reduce the module weight, decrease the thickness and lower down the cost.

Another object of the present invention is to provide a lamp cover with a bending structure and a backlight module to prevent the lamp cover from being deformed to turn over and so as to prevent the display area of the display from leaking light when suffering a shock.

To achieve the objects mentioned above, one embodiment of the present invention is to provide a lamp cover with a bending structure, which includes: a light part having a upper frame and a side frame connected to the upper frame; a supporting part having a first end and a second end, wherein the first end of the supporting part is connected to the side frame and the second end of the supporting part is configured away from the light part by a distance, and an accommodating space is set between the light part and the first end of the supporting part to accommodate a light source; and a bending part connected to the second end of the supporting part and bended into an angle.

To achieve the objects mentioned above, another embodiment of the present invention is to provide a backlight module, which includes a lamp cover, a light source, a light guide plate and a reflector film. The lamp cover includes: a light part having a upper frame and a side frame connected to the upper frame; a supporting part having a first end and a second end, wherein the first end of the supporting part is connected to the side frame and the second end of the supporting part is configured away from the light part by a distance; and an accommodating space is set between the light part and the first end of the supporting part; and a bending part connected to the second end of the supporting part and bended into an angle. The light source is set in the accommodating space of the lamp cover. The light guide plate and the reflector film are located on the supporting part of the lamp cover, and one side of them is inserted into the accommodating space of the lamp cover.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1A is a partial side-view schematic diagram of the structure of a conventional backlight module;

FIG. 1B is the solid schematic diagram of FIG. 1A;

FIG. 2A is a side-view schematic diagram of the structure of a lamp cover according to the first embodiment of the present invention;

FIG. 2B is a side-view schematic diagram of the structure of a lamp cover according to the second embodiment of the present invention;

FIG. 2C is a side-view schematic diagram of the structure of a lamp cover according to the third embodiment of the present invention;

FIG. 2D is a side-view schematic diagram of the structure of a lamp cover according to the fourth embodiment of the present invention;

FIG. 3A is a partial side-view schematic diagram of the structure of a backlight module according to a fifth embodiment of the present invention;

FIG. 3B is the solid schematic diagram of FIG. 3A; and

FIG. 3C is a partial side-view schematic diagram of the structure of a backlight module according to a sixth embodiment of the present invention.

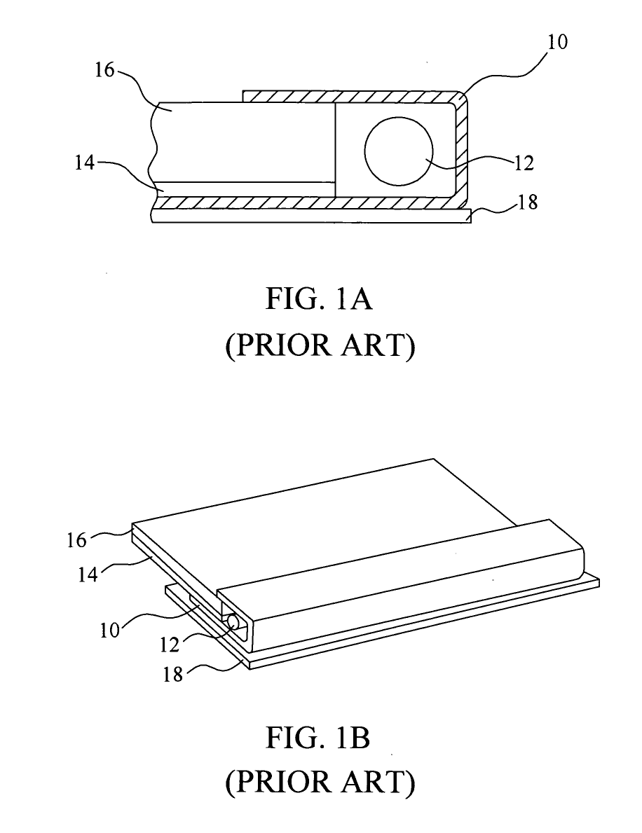

### DESCRIPTION OF THE PREFERRED EMBODIMENT

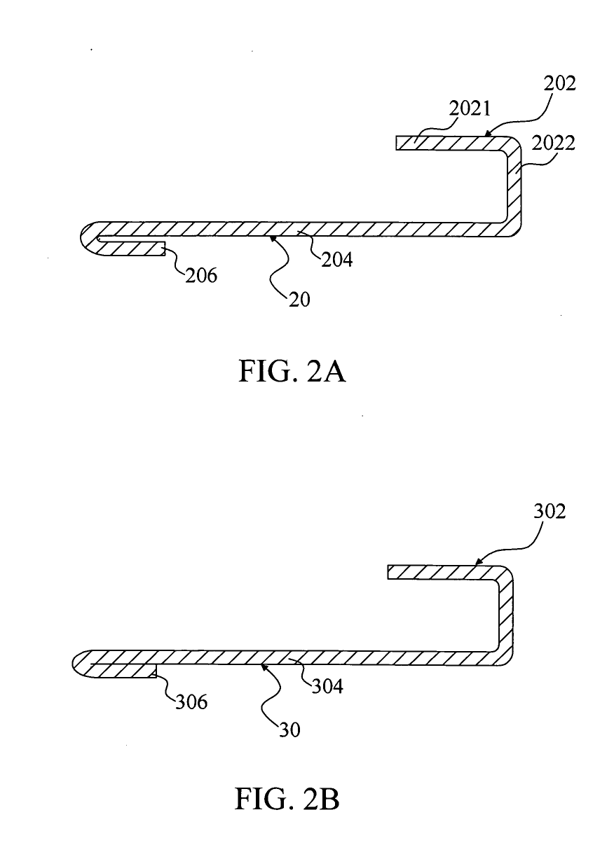

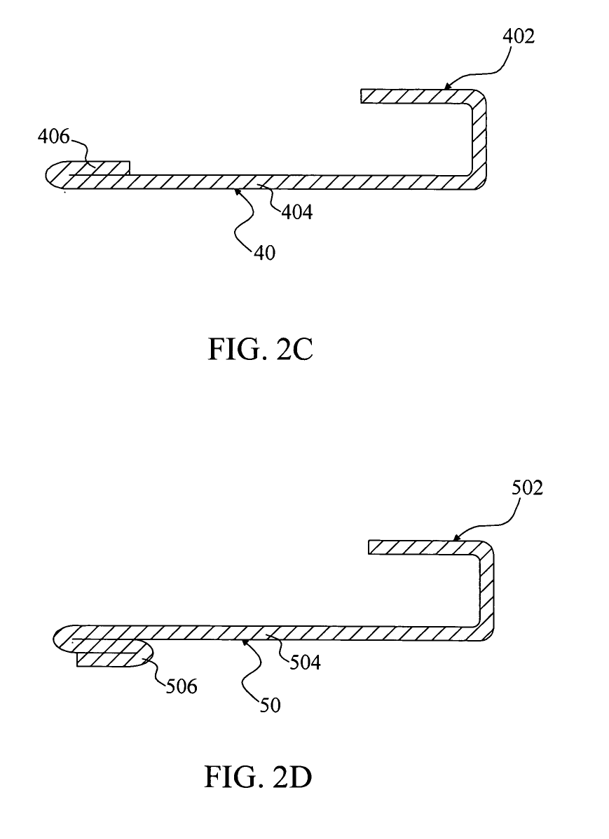

FIG. 2A is a side-view schematic diagram of the structure of a lamp cover according to the first embodiment of the present invention, a lamp cover 20 includes: a light part 202 having a upper frame 2021 and a side frame 2022 connected to the upper frame 2021; a supporting part 204 having a first end and a second end, wherein the first end of the supporting part 204 is connected to the side frame 2022 and the second end of the supporting part 204 is configured away from the light part 202 by a distance; and an accommodating space is set between the light part 202 and the first end of the supporting part 204 to accommodate a light source; and a bending part 206 connected to the second end of the supporting part 204 and bended into an angle.

In one embodiment, the material of the lamp cover 20 comprises aluminum, stainless steel, brass or a combination thereof.

In one embodiment, the lamp cover 20 is formed as an integrated piece.

In one embodiment, the bending part 206 is punched.

Please refer to FIG. 2A again; the end portion of the bending part 206 is substantially parallel to the supporting part 204 with a gap, and the end portion of the bending part 206 and the light part 202 are located in the different sides of the supporting part 204. It can be appreciated by the people skilled in the art that there exist many other possible embodiments to achieve the same purpose of the present invention.

FIG. 2B is a side-view schematic diagram of the structure of a lamp cover according to the second embodiment of the present invention, a lamp cover 30 includes a light part 302, a supporting part 304 and a bending part 306. The difference between the second embodiment and the first embodiment explained in FIG. 2A is that the end portion of the bending part 306 is disposed on the lower surface of the supporting part 304.

FIG. 2C is a side-view schematic diagram of the structure of a lamp cover according to the third embodiment of the present invention, a lamp cover 40 includes a light part 402, a supporting part 404 and a bending part 406. The differences between the third embodiment and the second embodiment explained in FIG. 2B are that the end portion of the bending part 406 and the light part 402 are located in the same side of the supporting part 404 and the end portion of the bending part 406 is disposed on the upper surface of the supporting part 404.

FIG. 2D is a side-view schematic diagram of the structure of a lamp cover according to the fourth embodiment of the present invention, a lamp cover 50 includes a light part 502, a supporting part 504 and a bending part 506. The difference between the fourth embodiment and the second embodiment explained in FIG. 2B is that the end portion of the bending part 506 is bended twice.

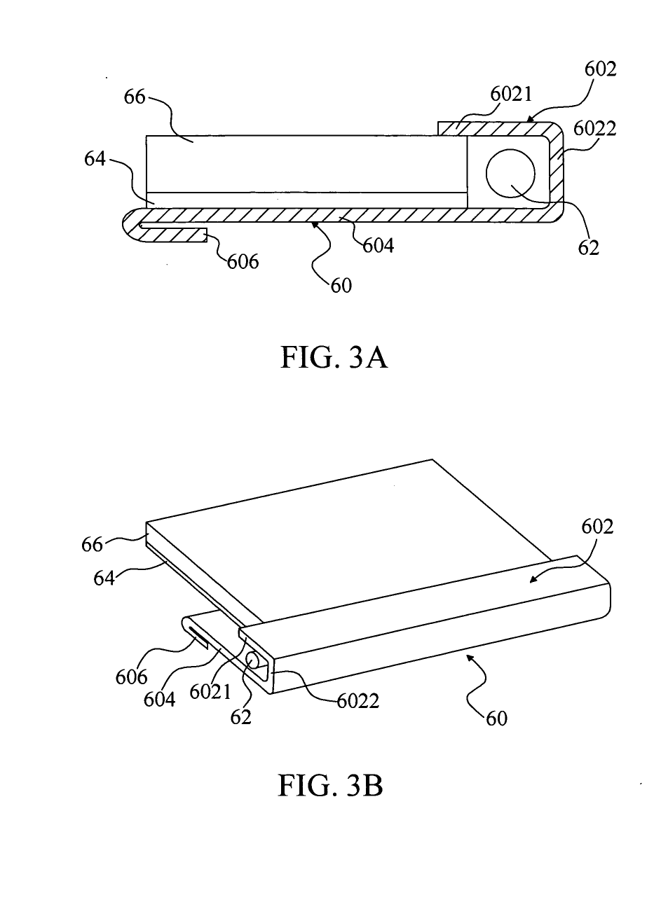

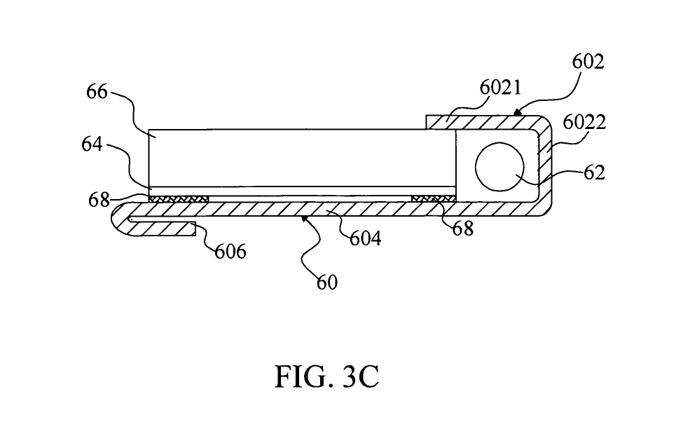

FIG. 3A is a partial side-view schematic diagram of the structure of a backlight module according to a fifth embodiment of the present invention, and FIG. 3B is the solid schematic diagram of FIG. 3A. A lamp cover 60 includes: a light part 602 having a upper frame 6021 and a side frame 6022 connected to the upper frame 6021; a supporting part 604 having a first end and a second end, wherein the first end of the supporting part 604 is connected to the side frame 6022 and the second end of the supporting part 604 is configured away from the light part 602 by a distance; and an accommodating space is set between the light part 602 and the first end of the supporting part 604 to accommodate a light source 62; and a bending part 606 connected to the second end of the supporting part 604 and bended into an angle. A light guide plate 66 and a reflector film 64 are located on the supporting part 604, and one side of them is inserted into the accommodating space of the lamp cover 60. The light emitted from the light source 62 is reflected by the light part 602 and the reflector film 64, and then irradiated out through the display area of the light guide plate 66 to provide the light source for the image display.

In one embodiment, the light source 62 is a Cold Cathode Fluorescent Lamp (CCFL) or an External Electrode Fluorescent Lamp (EEFL).

Please refer to FIG. 3A again; the end portion of the bending part 606 is substantially parallel to the supporting part 604 with a gap, and the end portion of the bending part 606 and the light part 602 are located in the different sides of the supporting part 604. It can be appreciated by the people skilled in the art that there exist many other possible embodiments to achieve the same purpose of the present invention. For example, the end portion of the bending part 606 and the light part 602 may be located in the same side of the supporting part 604 and the end portion of the bending part 606 may be disposed on the upper surface of the supporting part 604. Another example is that the end portion of the bending part 606 and the light part 602 may be located in the different sides of the supporting part 604 and the end portion of the bending part 606 may be disposed on the lower surface of the supporting part 604. It is not to further describe hereafter.

To further enhance the structural strength of the backlight module, it may set an adhesive between the reflector film and the supporting part of the lamp cover. FIG. 3C is a partial side-view schematic diagram of the structure of a backlight module according to a sixth embodiment of the present invention. At least an adhesive 68 is set between the reflector film 64 and the supporting part 604. In one embodiment, the adhesive 68 is a double-sided adhesive tape.

It can be understood by the people skilled in the art that the lamp cover structures of the present invention are suitable for various kinds of the FPD, such as the TFT-LCD. Moreover, the FPD adopting the backlight module of the present invention may be applied in versatile electronic apparatuses, such as a notebook computer, a laptop computer and a television.

Consequently, the structure of the lamp cover of the present invention can reinforce the structural strength of the backlight module to prevent the lamp cover from being deformed to turn over, and so as to prevent the display area of the display from leaking light when suffering a shock. Therefore, the present invention can effectively improve the display quality and the optical flavor of the display. Furthermore, the bending part of the lamp cover can be fabricated by the punching method that does not need extra part and assembling time.

The foregoing descriptions of specific embodiments of the present invention have been presented for purposes of illustrations and description. They are not intended to be exclusive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to particular use contemplated. It is intended that the scope of the invention be defined by the Claims appended hereto and their equivalents.

1. A lamp cover with a bending structure, comprising:
a light part having a upper frame and a side frame connected to the upper frame;
a supporting part having a upper surface, a lower surface, a first end and a second end,
wherein the first end of the supporting part is connected to the side frame and the second end of the supporting part is configured away from the light part by a distance, the upper surface is between the upper frame and the lower surface, and an accommodating space is set between the light part and the first end of the supporting part to accommodate a light source; and
a bending part connected to the second end of the supporting part and bended into an angle, wherein the bending part is disposed underneath the lower surface, such that the lower surface is between the upper surface and the bending part.

2. The lamp cover with a bending structure according to claim 1, wherein an end portion of the bending part is substantially parallel to the supporting part with a gap.

3-4. (canceled)

5. The lamp cover with a bending structure according to claim 1, wherein the material of the lamp cover comprises aluminum, stainless steel, brass or a combination thereof.

6. A backlight module, comprising:
a lamp cover, including:
a light part having a upper frame and a side frame connected to the upper frame;
a supporting part having a upper surface, a lower surface, a first end and a second end, wherein the first end of the supporting part is connected to the side frame and the second end of the supporting part is configured away from the light part by a distance, the upper surface is between the upper frame and the lower surface, and an accommodating space is set between the light part and the first end of the supporting part; and
a bending part connected to the second end onto supporting part and bended into an angle, wherein the bending part is disposed underneath the lower surface, such that the lower surface is between the upper surface and the bending part;
a light source set in the accommodating space; and
a light guide plate located on the supporting part, wherein one side of the light guide plate is inserted into the accommodating space.

7. The backlight module according to claim 6, further comprising a reflector film set between the light guide plate and the supporting part.

8. The backlight module according to claim 7, farther comprising at least an adhesive set between the reflector film and the supporting part.

9. The backlight module according to claim 8, wherein the adhesive is a double-sided adhesive tape.

10. The backlight module according to claim 6, wherein an end portion of the bending part is substantially parallel to the supporting part with a gap.

11-12. (canceled)

13. The backlight module according to claim 6, wherein the material of the lamp cover comprises aluminum, stainless steel, brass or a combination thereof.
